(19) United States
(12) Patent Application Publication
(10) Pub. No.: US 2015/0052459 A1
(43) Pub. Date: Feb. 19, 2015

(54) SHORTCUT COMMAND BUTTON FOR A HIERARCHY TREE

(71) Applicant: Rinu Sunil, Bangalore (IN)

(72) Inventor: Rinu Sunil, Bangalore (IN)

(73) Assignee: Unisys Corporation, Blue Bell, PA (US)

(21) Appl. No.: 14/085,902

(22) Filed: Nov. 21, 2013

(30) Foreign Application Priority Data
Aug. 13, 2013 (IN) 2404/DEL/2013

(51) Int. Cl. G06F 3/0482

(52) U.S. Cl. CPC G06F 3/0482
USPC 715/760

(57) ABSTRACT

Systems and methods are disclosed herein to a method for presenting a user interface comprising: receiving data from a host computer system describing a web-based user interface, wherein the data describing the web-based user interface includes information describing a hierarchical navigation tree and shortcut menu commands associated with each of the navigation elements; presenting the web-based user interface including the hierarchical navigation tree, the navigation elements, and shortcut buttons, wherein each shortcut button corresponds to and is adjacent to the one of the navigation elements; receiving a first selection from a user activating one of the shortcut buttons; displaying a shortcut menu comprising the shortcut menu commands associated with a navigation element corresponding to the selected shortcut button; receiving a second selection from the user, and transmitting a request to the host computer to perform a command.

### TECHNICAL FIELD

The present invention relates generally to user interfaces, and more particularly to a method of presenting a shortcut button in a hierarchy tree on a user interface.

### BACKGROUND

Graphical user interfaces (“GUI”) are common ways in which a computer system presents options and information and receives commands. Before GUIs, computer systems were commanded using low-level computer language or command-line parameters and commands. Low-level computer languages and command-line commands essentially required a user to learn a new language: the language understood by the computer. GUIs have replaced command lines to make computers more user-friendly, and most computer applications include a GUI. Due to the advancement of GUIs, a typical user does not need to understand computer language or DOS commands to command a computer because the buttons and menus of GUIs have replaced command-line for commanding the computer. Also, because the menus and buttons use plain language, a user can easily ascertain what functions the buttons or menu items will perform.

Generally, GUIs receive commands from a user when a user activates a button or menu item, and the GUI transforms the activation of the button or menu item into machine-understood commands. The machine-understood commands are performed in the background. So, GUIs streamline computer commands to make computers more user-friendly and efficient.

While GUIs are extremely important to the operation of a computer, a computer screen only has so much real estate for buttons and menus. In general, computer applications have many functions and understand many commands. So, in order to present all of those functions and commands in a graphical format, many buttons may need to appear on the screen. As the number of buttons on the screen increases, the GUI may begin to feel cluttered. A cluttered interface may be annoying to a user or make the GUI feel less user-friendly.

One method of presenting more selectable commands on a GUI is to present navigation buttons, such a links or icons. Selecting a navigation button causes the GUI to present a new page or a new pane displaying new information and more selectable buttons within the new page or pane. While this method presents a lot of commands and information to the user without cluttering each individual page or pane, the user must still navigate to the correct page or pane by selecting one or more navigation buttons. Navigating through multiple levels can be frustrating to users, especially when the GUI is web-based and a webpage must reload or refresh every time the user selects a navigation button.

### SUMMARY

The systems and methods described herein attempt to overcome the drawbacks discussed above by displaying a shortcut button adjacent to each navigation element within a hierarchical navigation tree in a user interface. The shortcut button displays a shortcut menu upon activation of the shortcut button. The shortcut menu presents commands that perform a command without causing the GUI to navigate to a new page or new pane corresponding to the selected hierarchical navigation tree element. As a result, a user may quickly perform commands reloading a page or pane, and the user interface is more user friendly.

In one embodiment, a method for presenting a user interface comprises: receiving, by a client computer, data from a host computer system describing a web-based user interface, wherein the data describing the web-based user interface includes information describing one or more navigation elements comprising a hierarchical navigation tree and one or more shortcut menu commands associated with each of the one or more navigation elements; presenting, by the client computer, the web-based user interface including the hierarchical navigation tree, the one or more navigation elements, and one or more shortcut buttons, wherein each shortcut button corresponds to and is adjacent to the one of the one or more navigation elements; receiving, by the client computer, a first selection from a user activating one of the one or more shortcut buttons; upon selection of the one of the one or more shortcut buttons, displaying, by the client computer, a shortcut menu comprising the one or more shortcut menu commands associated with a navigation element corresponding to the selected shortcut button; receiving, by the client computer, a second selection from the user, and transmitting, by the client computer, a request to the host computer to perform a command associated with a selected shortcut menu command when the second selection selects one of the one or more shortcut menu commands.

In another embodiment, a method for presenting a user interface comprises: receiving, by a client computer, data from a host computer system describing a web-based user interface, wherein the data describing the web-based user interface includes information describing one or more navigation elements comprising a hierarchical navigation tree, a sub-menu element, and one or more sub-menu commands and one or more shortcut menu commands associated with each of the one or more navigation elements; presenting, by the client computer, the web-based user interface including the hierarchical navigation tree, the one or more navigation elements, and one or more shortcut buttons, wherein each shortcut button corresponds to and is adjacent to the one of the one or more navigation elements; receiving, by the client computer, a first selection from a user activating one of the one or more shortcut buttons; upon selection of the one of the one or more shortcut buttons, displaying, by the client computer, a shortcut menu comprising the one or more shortcut menu commands associated with a navigation element corresponding to the selected shortcut button; receiving, by the client computer, a second selection from the user; and transmitting, by the client computer, a request to the host computer to perform a selected shortcut menu command when the second selection selects one of the one or more shortcut menu commands; displaying, by the client computer, a sub-menu adjacent to the shortcut menu comprising the one or more sub-menu commands when the second selection selects the sub-menu element; receiving, by the computer, a third selection from the user; and transmitting, by the computer, a request to the host computer to perform a selected sub-menu command when the third selection selects one of the one or more sub-menu commands.

In another embodiment, a computer program product, comprising a computer-usable medium, having a computer readable program code embodied therein, said computer readable program code adapted to be executed by a processor to implement a method for presenting a user interface, the method comprises: providing the user interface, wherein the user interface comprises distinct software modules, and wherein the distinct software modules comprise a hierarchical navigation tree module, a shortcut button module, and a shortcut menu module; requesting information from a host computer describing one or more hierarchical navigation tree elements comprising a hierarchical navigation tree, wherein the requesting information describing the one or more hierarchical navigation tree elements is performed by the hierarchical navigation tree module; requesting information from a host computer describing one or more shortcut menu commands, a sub-menu element, and one or more sub-menu commands associated with each navigation element in the hierarchical navigation tree, wherein the requesting information describing the one or more shortcut menu commands, the sub-menu element, and the one or more sub-menu commands is performed by the shortcut menu module; displaying the hierarchical navigation tree including the one or more one hierarchical navigation tree elements on the user interface, wherein displaying the hierarchical navigation tree is performed by the hierarchical navigation tree module; displaying one or more one shortcut buttons adjacent to the hierarchical navigation tree on the user interface and each shortcut button corresponds to one of the one or more hierarchical navigation tree elements, wherein displaying the one or more shortcut buttons is performed by the shortcut button module; upon selection of one of the one or more shortcut buttons, activating the shortcut menu module, wherein activating the shortcut menu module is performed by the shortcut button module; upon activation of the shortcut menu module, displaying a shortcut menu comprising the one or more shortcut menu commands and the sub-menu element associated with a navigation element corresponding to the selected shortcut button, wherein displaying the shortcut menu is performed by the shortcut menu module; and upon a selection of one of the shortcut menu commands from the shortcut menu, sending a request to the host computer to perform the shortcut menu command, wherein sending the request is performed by the shortcut menu module.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a computer system for presenting a user interface that includes a hierarchical navigation tree and a shortcut button within the hierarchical navigation tree to a client device according to an exemplary embodiment.

FIG. 2 illustrates a screen shot of the user interface having a hierarchical navigation tree according to an exemplary embodiment.

FIG. 3 illustrates a screen shot of a shortcut menu appearing adjacent to the hierarchical navigation tree upon selection of the shortcut button according to an exemplary embodiment.

FIG. 4 illustrates a screen shot of an sub-menu appearing adjacent to the shortcut menu according to an exemplary embodiment.

FIG. 5 illustrates a flow chart for presenting the hierarchical navigation tree shortcut button on a user interface according to an exemplary embodiment.

### DETAILED DESCRIPTION

Reference will now be made in detail to the preferred embodiments, examples of which are illustrated in the accompanying drawings.

The embodiments described above are intended to be exemplary. One skilled in the art recognizes that numerous alternative components and embodiments may be substituted for the particular examples described herein and still fall within the scope of the invention.

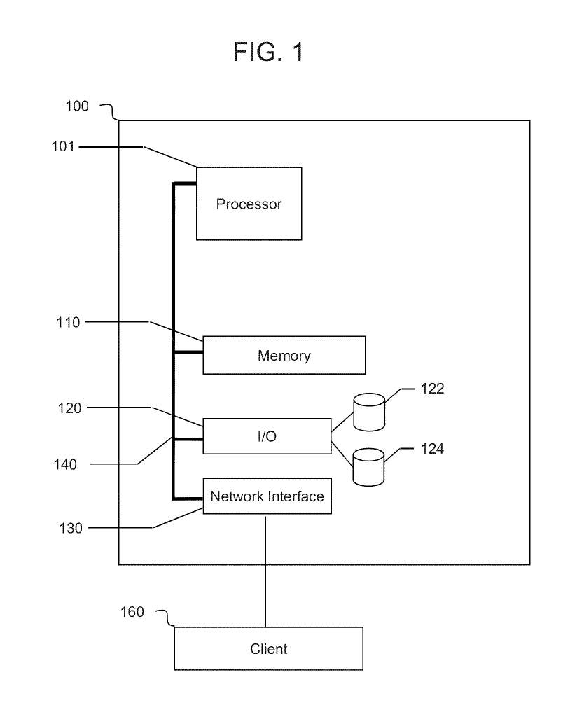

Referring to FIG. 1, a host computer system 100 may include a processor 101, a memory 110, an input/output (I/O) interface 120, a network interface 130, and a data bus 140. The processor 101, the memory 110, the I/O interface 120, the network interface 130 may all communicate with one another through the data bus 140. While the elements listed above are illustrated in FIG. 1, it is to be understood that the host computer system 100 may include many more computing components, such as a graphics module, a hard drive, a CD-ROM drive, DVD-ROM drive, tape drive, audio modules, universal serial bus (USB) ports, power supplies, cooling devices, heat sinks, or any other components that may be included in a computing device. The performance specifications and configuration of the host computing system 100 may vary depending on computing model or customer need.

The processor 101 may be embodied by one or more processors if the host computer system 100 is a multi-processor system. If the host computer system 100 has multiple processors, each processor may perform a different task, and each processor may be differently configured to accomplish their specific tasks. Alternatively, all of the processors may be constructed in the same manner, and one or more of the processors may be a spare processor included for redundancy. Additionally, one or more of the processors may be included to provide supervisory control over the other processors.

The memory 110 may include any computer storage medium, either volatile or non-volatile, removable or non-removable, such as FLASH, RAM, ROM, EEPROM, or any other storage medium that is configured to store information according to any method or technology for information storage. The memory 110 is configured to store computer readable information, such as computer readable instructions and data. The memory 110 may be implemented to store program code to direct the processor 101 to process information and requests to or from other computing systems connected to the host computer system 100 in any manner, such as through the network interface 130. The memory 110 may also be implemented to store program code to direct the processor 101 and the I/O interface 120 to present a user interface to a user.

The network interface 130 provides a network connection means and network protocols useful for sending and receiving information from and to other computer systems connected to the host computer system 100. The network interface 130 may be connected to a network of any type, such as a local area network (LAN), a wide area network (WAN), or a wireless local area network (WLAN). The network interface 130 may communicate with other computer systems, such as a client computer 160, on the network through network protocols, such as TCP/IP, FTP, SSH, or any other network protocol. In addition, the network interface 130 may be connected to a network through any means including wireless means, such as Bluetooth, IEEE 802.11, and infrared, or wired means, such as Ethernet, firewire, and coaxial.

Peripheral devices 122 and 124 may be connected to the I/O interface 120, and the peripheral devices 122 and 124 allow the host computer system 100 to receive inputs from a user and output data and information to the user. The host computer system 100 may include more or less than two peripheral devices. The peripheral devices 122 and 124 may include a mouse, a keyboard, a monitor, a printer, a scanner, a touch screen, buttons, or any other peripheral device useful for receiving data from a user and outputting data to a user. In the following example, the first peripheral device 122 is a display, and the second peripheral device 124 is a mouse. An operator of the host computer system 100 may configure the host computer system 100 using the peripheral devices 122, 124. Alternatively, the client computer 160 that is connected to the host computer system 100 may configure the host computer system 100. The client computer 160 may connect to the host computer system 100 over a communications network through the network interface 130.

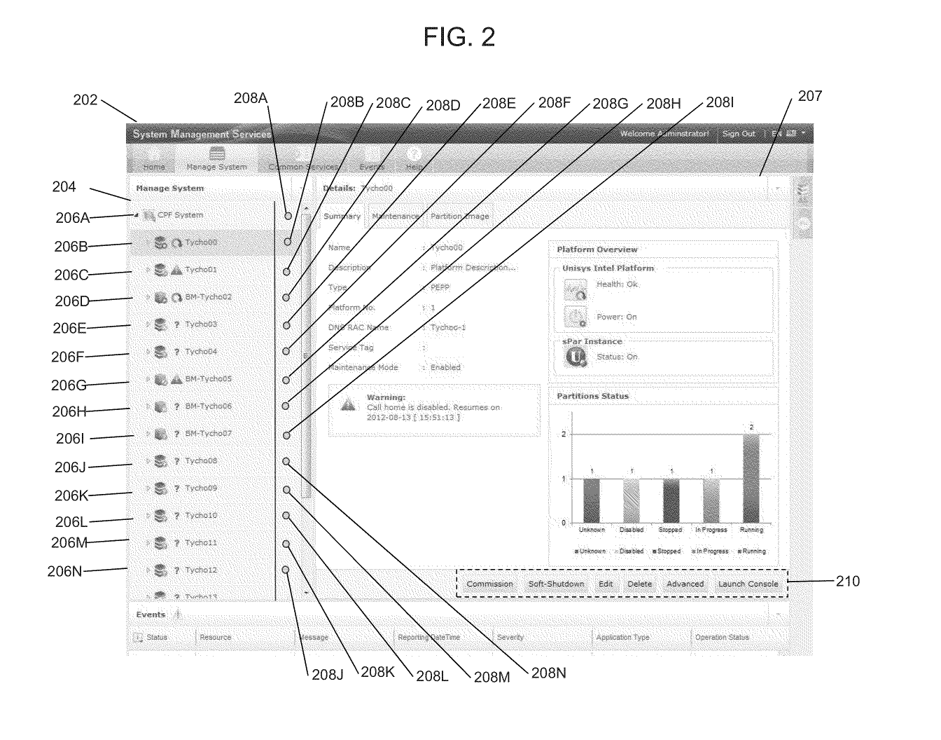

An operator may manage settings, configurations, or applications of the host computer system 100 through a user interface. An exemplary computer system user interface is illustrated in FIGS. 2-4. An operator may also view status updates of the host computer system 100 or control operations and processes of the host computer system 100 using the user interface. For example, the user interface may be a web interface displayed on the client computer 160, and an operator may change settings or view information about the host computer system 100 by connecting to the host computer system 100 remotely. The user interface may have a plurality of different buttons and information presented. The user interface may have a hierarchical navigation tree for managing multiple similar items, which are organized in a hierarchy. For example, each element in the hierarchical navigation tree may be a computer platform, a computing partition, or a commissioned virtual machine.

As shown in FIG. 2, the computer system displays a user interface 202 to a user. Included in the user interface 202 is a hierarchical navigation tree 204. The hierarchical navigation tree 204 has a plurality of elements 206A-N. The number of elements in the hierarchical navigation tree 204 may vary depending on the number of navigation elements a user has created or a number or pre-existing navigation elements. Each element 206A-N may correspond to a file, a folder, a virtual machine, a platform, a computer system, a partition, an email, or any type of hierarchy. In the exemplary user interface of FIG. 2, each navigation element 206A-N is a system, a platform, a partition, or a virtual machine. Continuing this example, the number of elements in the hierarchical navigation tree 204 of FIG. 2 matches the number of platforms running on or associated with a host computer system.

Activating a navigation element 206A-N may update a pane 207 within the user interface. The pane 207 presents information, links to other panes, and commands to the user. Clicking a new navigation element 206A-N causes the pane 207 to reload or refresh with new information and commands associated with the newly selected navigation element 206A-N.

The hierarchical navigation tree 204 may include expand/collapse buttons that respectively show or hide all elements underneath each navigation element. The expand/collapse buttons show or hide lower hierarchy level navigation elements, if such a lower hierarchy level navigation element exists. For example, FIG. 2 illustrates that the CPF System navigation element 206A, which is the top level of the hierarchical navigation tree 204, is expanded. As a result, the user interface 202 displays all the platforms 206B-N under the CPF system navigation element 206A. Some of the navigation elements 206B-N may be further expanded, such as navigation elements 206B-F and 206J-N, although FIG. 2 does not show expansion of these elements of the hierarchical navigation tree 204. Under each platform navigation element 206B-N may be partition navigation elements representing partitions of each platform.

Each navigation element 206A-N has a corresponding shortcut button 208A-N. Each shortcut button 208A-N is directly adjacent to its corresponding navigation element 206A-N. Upon activation of one of the shortcut buttons 208A-N, the client computer displays a shortcut menu comprising commands for the selected navigation element 208A-N. The shortcut menu presents commands that correspond to command buttons 210 within the pane 207.

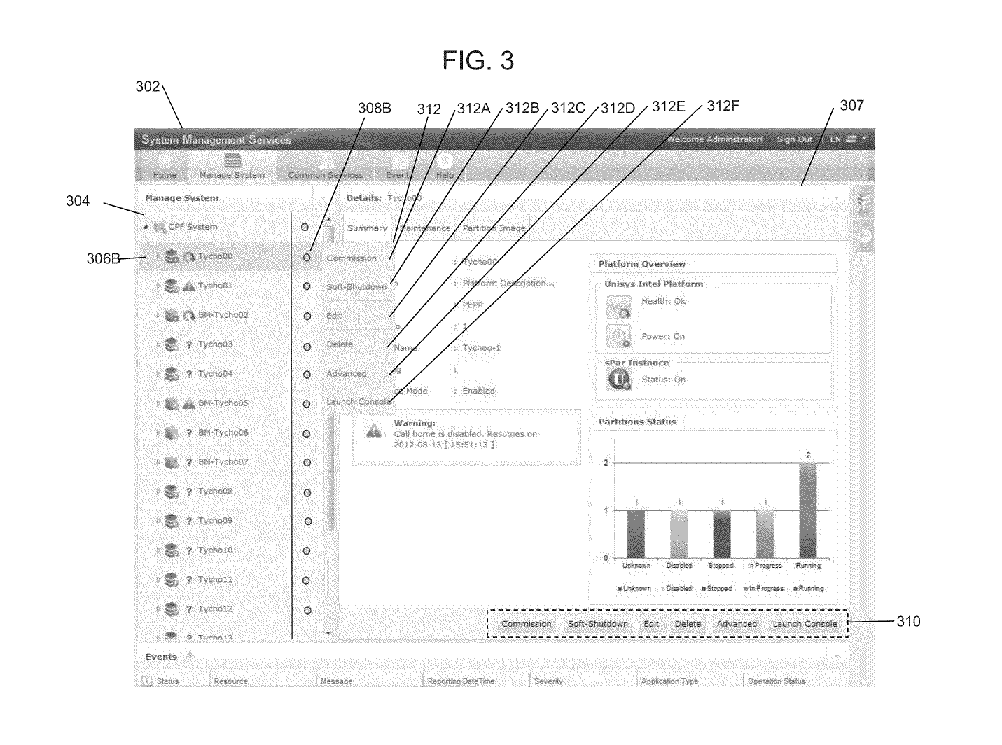

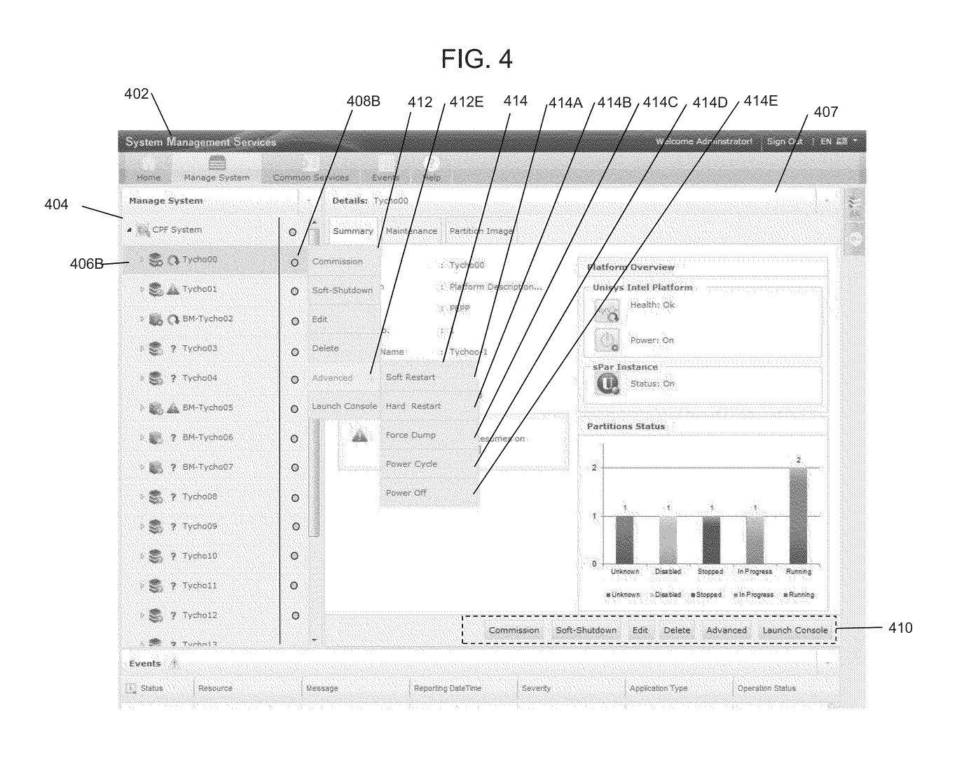

FIG. 3 illustrates a shortcut menu 312 in the user interface 302. The shortcut menu 312 appears adjacent to the shortcut button 308B when a user activates the shortcut button 308B. The shortcut menu 312 may include any number of commands or elements 312A-F. In FIG. 3, the shortcut menu 312 includes six elements: a commission command 312A, a soft-shutdown command 312B, an edit command 312C, the delete command 312D, a launch console command 312F, and an advanced sub-menu element 312E that activates a sub-menu (which is described in more detail in FIG. 4).

As shown in FIG. 3, the commands and elements 312A-F of the shortcut menu 312 match the command buttons 310 in the pane 307. As a result, the commands and elements 312A-F of the shortcut menu 312 are context sensitive because the pane 307 for one navigation element 308B may present different command buttons than another navigation element, but the shortcut menu 312 may always match the command buttons 310 displayed in the pane 307.

In order to generate the shortcut menu 312, The host computer system may generate the list of shortcut command buttons and sub-menu elements 312A-F that comprise the shortcut menu 312 when loading the hierarchical navigation tree for the client device. As described above, the user interface is web-based, so the host computer system loads and generates data that, when processed by a client computer, generates the graphical user interface 302. When the client computer receives the data, the client computer interprets the data and displays the user interface 302 to the user on a screen. The data describing the hierarchical navigation tree 304 may include information describing the commands and elements 312A-F associated with each shortcut button 308A-N. The host computer system may package the commands 310 for each pane 307 with the data describing each navigation element 306A-N. Thus, when a user activates the shortcut button 308B, the client device can display the shortcut menu 312 without sending a message to the host computer requesting information describing the shortcut menu 312. In other words, no network communications take place in response to a user activating the shortcut button 308B.

The shortcut menu 312 allows a user navigating the hierarchical navigation tree 304 to perform a command on a navigation element 306A-N without loading the pane 307. As stated above, the user interface is web-based so loading the pane 307 requires the client device operated by the user to send a request to update the pane 307 over a network, wait for a response from the host computer system, receive data from the host computer system, process the data, and display the new pane 307. While modern network speeds have greatly sped up this process, the user may skip the step of loading the pane 307 and perform a command on the navigation element 308B by interacting with the hierarchical navigation tree 304 through the shortcut menu 312. For example, a user may activate the shortcut button 308B associated with the platform Tycho00 navigation element 306B and select the delete command 312D to delete the platform Tycho00. The delete command 312D may be performed without loading the pane 307 associated with the platform Tycho00 navigation element 306B. As a result, commands may be executed faster than if the pane 307 was first loaded.

The advanced menu element 312E does not perform a command but rather opens a sub-menu. As shown in FIG. 4, upon activating the advanced sub-menu element 412E, a sub-menu 414 appears in the user interface 402 adjacent to the shortcut menu 412. Activating the advanced menu element 412E may comprise clicking the advanced menu element 412E, hovering a mouse cursor over the advanced menu element 412E, touching the advanced menu element 412E on a touch screen, or any other computer recognized activation manner.

The sub-menu 414 may include a plurality of sub-menu elements 414A-E. For example, FIG. 4 illustrates five sub-menu elements: a soft reset command 414A, a hard reset command 414B, a force dump command 414C, a power cycle command 414D, and a power off command 414E. A sub-menu 414 may not be applicable for all hierarchical navigation tree elements, but may be a useful way to layer the commands and make the user interface more user friendly.

While the exemplary embodiments describe and illustrate a graphical user interface 402 for the management of computer systems, computer partitions, and virtual machines, the hierarchical navigation tree shortcut button 408B may be applied to any hierarchical navigation tree 404 hierarchy on a web-based user interface 402. For example, a file and folder hierarchy presented on a web-based user interface 402 may also include a shortcut button 408B and shortcut menu 412 for quickly performing actions and commands on files and folders in the file structure. In another example, email structured in a folder hierarchy may also implement the shortcut button 408B and shortcut menu 412 within a hierarchical navigation tree 404 of an email organization system. In other words, the exemplary embodiments are not limited to a hierarchical navigation tree 404 presenting computer systems, computer partitions and virtual machines.

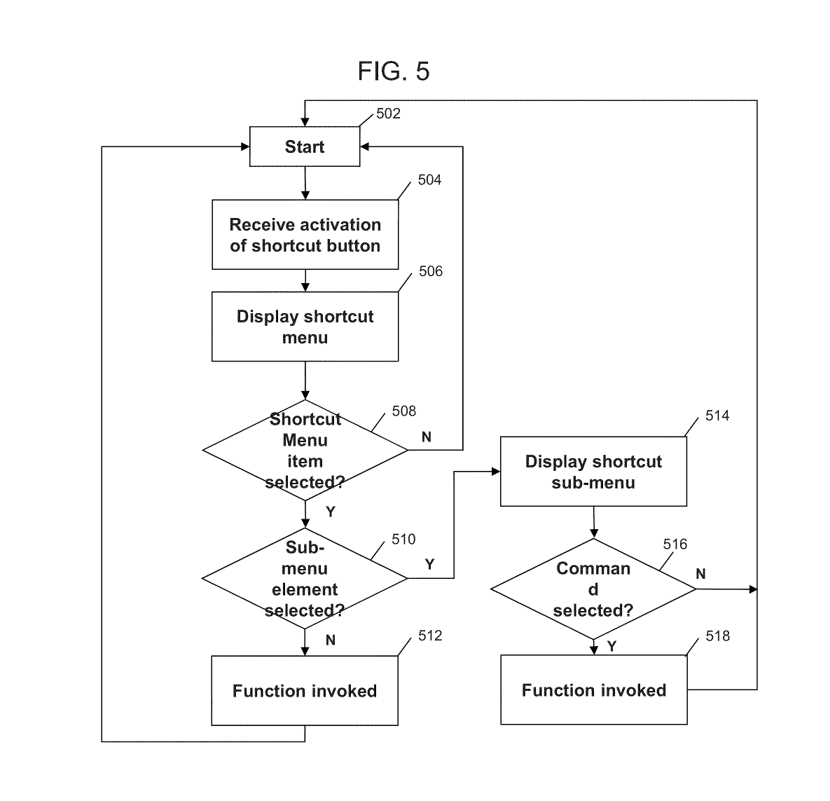

FIG. 5 illustrates a flow chart for presenting the hierarchical navigation tree shortcut button. The flow begins at step 502 and a client computer system waits for a user to activate the hierarchical navigation tree shortcut button. In step 504, the client computer system receives an activation of the hierarchical navigation tree shortcut button by the user. Activation of the hierarchical navigation tree shortcut button may be performed by selecting the hierarchical navigation tree shortcut button (e.g. by a mouse click or touch), moving a mouse cursor over the hierarchical navigation tree shortcut button, or receiving a keyboard shortcut command, or any other method of user interface button selection. Upon receiving the activation of the hierarchical navigation tree shortcut button, the client computer system displays the hierarchical navigation tree shortcut menu containing the shortcut command buttons and sub-menu elements associated with the selected navigation element in step 506. As described above, the shortcut command buttons and sub-menu elements displayed in the shortcut menu may depend on the context of the user interface, so a host computer system may determine which shortcut command buttons and sub-menu elements correspond to each navigation element by referencing the memory of the host computer system, which may be performed before sending data to the client device describing the appearance and function of the user interface. The host computer system may transmit information describing the shortcut menu command buttons and sub-menu elements associated with each navigation element in the hierarchical navigation tree when transmitting data describing the user interface to the client device.

After displaying the shortcut menu, the client computer system waits until a user performs an action and determines if the user has selected one of the shortcut menu commands or sub-menu elements in step 508. If no shortcut menu button is selected, the flow returns to step 502. For example, the computer system may display the shortcut menu for a predetermined period of time before hiding the shortcut menu again. If the shortcut menu appears when a mouse cursor scrolls over the hierarchical navigation tree shortcut button, the shortcut menu may hide when the mouse cursor is no longer scrolling over the hierarchical navigation tree shortcut button or the shortcut menu. After receiving activation of one of the shortcut menu commands or sub-menu elements, the client computer determines if the selection was a shortcut menu command button or a shortcut menu sub-menu element in step 510. If a user has selected one of the shortcut command buttons, the client computer system invokes the selected function in step 512 by transmitting the command button selection to the host computer. After receiving the command, the host computer performs the requested command. If a user has selected a sub-menu element, the client computer displays a sub-menu adjacent to the selected sub-menu element in step 514. After displaying the shortcut sub-menu, the client computer system waits until a user performs an action and determines if the user has selected one of the sub-menu commands in step 516. It should be noted that, although not described in FIG. 5, the sub-menu may also include another sub-menu, and so, the shortcut menu may have n-levels. If no shortcut sub-menu button is selected, the flow returns to step 502. For example, the computer system may display the shortcut sub-menu for a predetermined period of time before hiding the shortcut menu and shortcut sub-menu again. If the shortcut sub-menu appears when a mouse cursor scrolls over the sub-menu element in the shortcut menu, the shortcut sub-menu may hide when the mouse cursor is no longer scrolling over the sub-menu element or the sub-menu. After receiving activation of one of the shortcut sub-menu commands, the client computer system invokes the selected function in step 518 by transmitting the command button selection to the host computer. After receiving the command, the host computer performs the requested command.

According to the exemplary embodiments described herein, the shortcut button in the hierarchical navigation tree produces a shortcut menu presenting commands for the navigation element upon the activation of the shortcut button. The user interface displays the shortcut menu after activation of the advanced button, and so, the user may skip the step of loading a page or pane of a web-based user interface, and the user interface is more user friendly.

The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, those skilled in the art will appreciate that one or more acts described herein may be performed by hardware, software, or a combination thereof, as may be embodied in one or more computing systems.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “displaying” or “receiving” or “referencing” or “changing” or “refreshing” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that numerous alternative components and embodiments that may be substituted for the particular examples described herein and still fall within the scope of the invention.

What is claimed is:

1. A method for presenting a user interface comprising:
receiving, by a client computer, data from a host computer system describing a web-based user interface, wherein the data describing the web-based user interface includes information describing one or more navigation elements comprising a hierarchical navigation tree and one or more shortcut menu commands associated with each of the one or more navigation elements;
presenting, by the client computer, the web-based user interface including the hierarchical navigation tree, the one or more navigation elements, and one or more shortcut buttons, wherein each shortcut button corresponds to and is adjacent to the one of the one or more navigation elements;
receiving, by the client computer, a first selection from a user activating one of the one or more shortcut buttons;
upon selection of the one of the one or more shortcut buttons, displaying, by the client computer, a shortcut menu comprising the one or more shortcut menu commands associated with a navigation element corresponding to the selected shortcut button;
receiving, by the client computer, a second selection from the user; and
transmitting, by the client computer, a request to the host computer to perform a command associated with a selected shortcut menu command when the second selection selects one of the one or more shortcut menu commands.

2. The method of claim 1, wherein each of the one or more navigation elements includes an expand/collapse button that, when activated, displays or hides lower-level navigation elements below each navigation element in the hierarchical navigation tree.

3. The method of claim 1, wherein the user interface includes a pane adjacent to the hierarchical navigation tree that is loaded whenever the user selects one of the one or more navigation elements.

4. The method of claim 3, wherein the pane includes one or more command buttons, and the one or more command buttons perform the same commands as the one or more shortcut menu commands in the shortcut menu.

5. The method of claim 3, wherein activation of one of the one or more shortcut menu commands transmits a selected command without loading the pane.

6. The method of claim 1, wherein each navigation element corresponds to a computer system, a computer platform, a computer partition, or a virtual machine.

7. The method of claim 6, wherein the commands comprising the one or more shortcut menu commands request the host computer system to commission a virtual machine, soft-shutdown a computer platform, edit a computer platform, delete a computer platform, and launch a console.

8. A method for presenting a user interface comprising:
receiving, by a client computer, data from a host computer system describing a web-based user interface, wherein the data describing the web-based user interface includes information describing one or more navigation elements comprising a hierarchical navigation tree, a sub-menu element, and one or more sub-menu commands and one or more shortcut menu commands associated with each of the one or more navigation elements;
presenting, by the client computer, the web-based user interface including the hierarchical navigation tree, the one or more navigation elements, and one or more shortcut buttons, wherein each shortcut button corresponds to and is adjacent to the one of the one or more navigation elements;
receiving, by the client computer, a first selection from a user activating one of the one or more shortcut buttons;
upon selection of the one of the one or more shortcut buttons, displaying, by the client computer, a shortcut menu comprising the one or more shortcut menu commands associated with a navigation element corresponding to the selected shortcut button;
receiving, by the client computer, a second selection from the user; and
transmitting, by the client computer, a request to the host computer to perform a selected shortcut menu command when the second selection selects one of the one or more shortcut menu commands;
displaying, by the client computer, a sub-menu adjacent to the shortcut menu comprising the one or more sub-menu commands when the second selection selects the sub-menu element;
receiving, by the computer, a third selection from the user; and
transmitting, by the computer, a request to the host computer to perform a selected sub-menu command when the third selection selects one of the one or more sub-menu commands.

9. The method of claim 8, wherein each of the one or more navigation elements includes an expand/collapse button that, when activated, displays or hides lower-level navigation elements below each navigation element in the hierarchical navigation tree.

10. The method of claim 8, wherein the user interface includes a pane adjacent to the hierarchical navigation tree that is loaded whenever the user selects one of the one or more navigation elements.

11. The method of claim 10, wherein the pane includes one or more command buttons, and the one or more command buttons perform the same commands as the one or more shortcut menu commands in the shortcut menu.

12. The method of claim 10, wherein activation of the one of the shortcut menu commands transmits the selected shortcut menu command without loading the pane.

13. The method of claim 10, wherein activation of the one of the sub-menu commands transmits the selected sub-menu command without loading the pane.

14. The method of claim 10, wherein the pane includes an advanced menu button displaying one or more advanced menu commands upon activation of the advanced menu button, and the advanced menu commands perform the same commands as the one or more sub-menu commands

15. The method of claim 8, wherein each navigation element corresponds to a computer system, a computer platform, a computer partition, or a virtual machine.

16. The method of claim 15, wherein the commands comprising the one or more shortcut menu commands request the host computer system to commission a virtual machine, soft-shutdown a computer platform, edit a computer platform, delete a computer platform, and launch a console.

17. The method of claim 15, wherein the commands comprising the one or more sub-menu commands request the host computer system to soft reset a computer platform, hard reset a computer platform, force-dump a computer platform, power cycle a computer platform, or power off a computer platform.

18. A computer program product, comprising a computer-usable medium, having a computer readable program code embodied therein, said computer readable program code adapted to be executed by a processor to implement a method for presenting a user interface, the method comprising:
providing the user interface, wherein the user interface comprises distinct software modules, and wherein the distinct software modules comprise a hierarchical navigation tree module, a shortcut button module, and a shortcut menu module;
requesting information from a host computer describing one or more hierarchical navigation tree elements comprising a hierarchical navigation tree, wherein the requesting information describing the one or more hierarchical navigation tree elements is performed by the hierarchical navigation tree module;
requesting information from a host computer describing one or more shortcut menu commands, a sub-menu element, and one or more sub-menu commands associated with each navigation element in the hierarchical navigation tree, wherein the requesting information describing the one or more shortcut menu commands, the sub-menu element, and the one or more sub-menu commands is performed by the shortcut menu module;
displaying the hierarchical navigation tree including the one or more one hierarchical navigation tree elements on the user interface, wherein displaying the hierarchical navigation tree is performed by the hierarchical navigation tree module;
displaying one or more one shortcut buttons adjacent to the hierarchical navigation tree on the user interface and each shortcut button corresponds to one of the one or more hierarchical navigation tree elements, wherein displaying the one or more shortcut buttons is performed by the shortcut button module;
upon selection of one of the one or more shortcut buttons, activating the shortcut menu module, wherein activating the shortcut menu module is performed by the shortcut button module;
upon activation of the shortcut menu module, displaying a shortcut menu comprising the one or more shortcut menu commands and the sub-menu element associated with a navigation element corresponding to the selected shortcut button, wherein displaying the shortcut menu is performed by the shortcut menu module; and
upon a selection of one of the shortcut menu commands from the shortcut menu, sending a request to the host computer to perform the shortcut menu command, wherein sending the request is performed by the shortcut menu module.

19. The computer program product of claim 18, further comprising:
upon selection of the sub-menu element in the shortcut menu, displaying a sub-menu comprising the one or more sub-menu commands associated with the navigation element corresponding to the selected shortcut button, wherein displaying the shortcut sub-menu is performed by the shortcut menu module; and
upon a selection of one of the one or more sub-menu commands from the sub-menu, sending a request to the host computer to perform the sub-menu command.

20. The computer program product of claim 18, further comprising:
upon selection of the navigation element, sending a request to a host computer for data describing information to be presented in a pane of the user interface adjacent to the hierarchical navigation tree, wherein the request is sent by the hierarchical navigation tree module.
